(19) United States
(12) Patent Application Publication
(10) Pub. No.: US 2007/0211055 A1
(43) Pub. Date: Sep. 13, 2007

(54) Adaptive degradation

(75) Inventors: Matthew Stein, Novato, CA (US); Jose Madeira de Freitas Garcia, San Francisco, CA (US)

Correspondence Address: GATES & COOPER LLP;HOWARD HUGHES CENTER, 6701 CENTER DRIVE WEST, SUITE 1050, LOS ANGELES, CA, 90045, US

(73) Assignee: Autodesk, Inc.

(21) Appl. No.: 11/372,827

(22) Filed: Mar. 10, 2006

(51) Int. Cl. G06T 15/00

(52) U.S. Cl. 345/428; 345/522

(57) ABSTRACT

A method, apparatus, and article of manufacture provide the ability adaptively render/adjust a display. A visual style comprising an encapsulated set of one or more (or all of the) display properties may be set. An adaptive degradation chain is then determined/established that comprises an ordered sequence of the display properties. The ordered sequence determines an order for changing the one or more display properties when adjusting a rendering quality. The rendering quality is set. The rendering quality is temporarily adjusted by changing one or more of the display properties based on the adaptive degradation chain.

### BACKGROUND OF THE INVENTION

1. Field of the Invention.

The present invention relates generally to graphic display rendering quality, and in particular, to a method, apparatus, and article of manufacture for adaptively degrading a visual display rendering based on user specifications.

2. Description of the Related Art.

Software programs are often used to render images on a display device. However, as the images to be rendered increase in complexity, the frame rendering rate and quality of the rendered images may decrease. For example, because three-dimensional (3D) programs are complex and calculation intensive, users may not be able to interactively design/work in a mode where the visual display is fully rendered. Such rendering limitations may be based on the hardware capabilities of the particular computer that is used to render the image(s). Accordingly, it is desirable to provide a software based method that accommodates complex graphic rendering and hardware limitations.

Various prior art methods are used to adjust the image quality that is rendered. For example, prior art 3D programs may employ an interactive working mode/environment (in which the program is rendering at a particular quality) that uses a lower-quality rendering settings. Such a prior art program may then move to a higher quality mode either when explicitly triggered, or during idle. For example, the system may render using Gouraud shading rather than Phong shading when in a low quality setting. In Phong shading, lighting calculations are made at each individual point to provide an accurate representation of the shading based on the lighting in a scene. However, in Gouraud shading, every vertex of a polygon has a color calculated based on its orientation to the light source(s) of the scene. The colors are then interpolated across the face providing a smoothing effect. Thus, while Gouraud computes shading based on polygonal points, Phong shading computes shading based on every pixel (thereby creating a more accurate and more calculation intensive RGB value for each pixel).

Many prior art programs may also allow a user to explicitly set a preference for the low-quality interactive display mode—such as Gouraud shading—that provides the user a reasonable level of both quality and interactivity. However, such a single user configured low quality setting may not always result in the highest-quality display experience for the user. In this regard, the level of interactivity during design is typically a function of how many frames per second the computer (i.e., hardware) is able to render. Such rendering capabilities are also a function of scene complexity, the rendering algorithm used, and the rendering settings (among other properties). When the requested rendering is too complex, the display and mouse motions may not be smooth but may be sporadic, intermittent, and erratic.

The present invention overcomes the problems of the prior art and improves the display quality for 3D users working in an interactive display mode by providing greater granularity over 3D rendering options, and by establishing render targets.

### SUMMARY OF THE INVENTION

Many computer applications are graphics and calculation intensive. Accordingly, users may not be able to interactively design/work in a mode where the display is fully rendered.

The invention provides the ability to adaptively degrade the rendering quality of a display. Further, the user can control how the display is degraded. A degradation chain is established that defines the order/sequence in which various properties/settings are degraded. The user can change which settings are in the chain as well as order of the settings in the chain.

Based on the chain, the display may be manually or automatically degraded. In a manual degradation, the user can elect to increase or decrease the rendering quality that will adjust the display based on the chain.

In an automatic mode, a target frame rate is established. If the actual frame rate drops below the target frame rate (e.g., by a predetermined/user-defined threshold), the system will automatically degrade the rendering quality based on the degradation chain. Thus, the properties will be modified according to the settings in the chain. The rendering quality may be degraded until the target frame rate is achieved. Thereafter, the system may continue to monitor the frame rate and if it increases, the system may automatically increase the rendering quality until the target frame rate is achieved once again.

### BRIEF DESCRIPTION OF THE DRAWINGS

Referring now to the drawings in which like reference numbers represent corresponding parts throughout:

FIG. 1 is an exemplary hardware and software environment used to implement one or more embodiments of the invention;

FIG. 2 is a block diagram that illustrates the components of the graphics program of FIG. 1 in accordance with one or more embodiments of the invention;

FIG. 3 is a block diagram that illustrates the structure of an object list maintained by the 3D databases of FIG. 2 in accordance with one or more embodiments of the invention;

FIG. 4 illustrates a dialog window used to modify a degradation chain in accordance with one or more embodiments of the invention;

FIG. 5 illustrates a dialog box displayed when the user clicks the manual tune button of FIG. 4;

FIG. 6 illustrates a dialog or visual style panel that may be used to manually adjust the rendering quality in accordance with one or more embodiments of the invention; and

FIG. 7 is a flow chart illustrating the logical flow for rendering a display in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Overview

Embodiments of the invention overcome the problems of the prior art by providing the ability to define an adaptive degradation chain that is used to adjust the quality of a rendered display. Users may adjust the degradation chain by adding or removing properties in the chain or modifying the order of properties within the chain. The quality may be adjusted manually by the user or may be automatically adjusted without user interaction as the system analyzes the rendering quality (e.g., frame rate).

### Hardware Environment

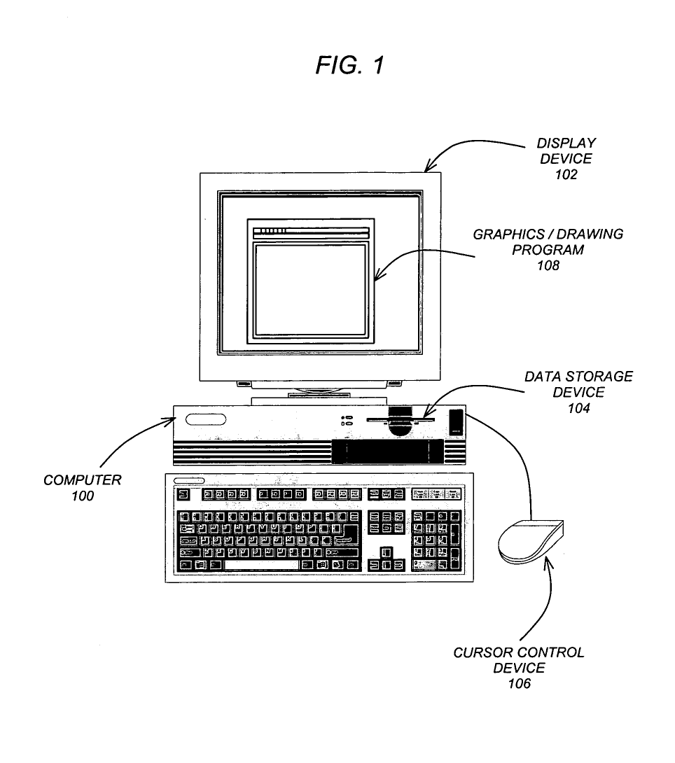

FIG. 1 is an exemplary hardware and software environment used to implement one or more embodiments of the invention. Embodiments of the invention are typically implemented using a computer 100, which generally includes, inter alia, a display device 102, data storage devices 104, cursor control devices 106, and other devices. Those skilled in the art will recognize that any combination of the above components, or any number of different components, peripherals, and other devices, may be used with the computer 100.

One or more embodiments of the invention are implemented by a computer-implemented graphics program 108, wherein the graphics program 108 is represented by a window displayed on the display device 102. Generally, the graphics program 108 comprises logic and/or data embodied in/or readable from a device, media, carrier, or signal, e.g., one or more fixed and/or removable data storage devices 104 connected directly or indirectly to the computer 100, one or more remote devices coupled to the computer 100 via a data communications device, etc.

Those skilled in the art will recognize that the exemplary environment illustrated in FIG. 1 is not intended to limit the present invention. Indeed, those skilled in the art will recognize that other alternative environments may be used without departing from the scope of the present invention.

### Computer-Implemented Graphics Program

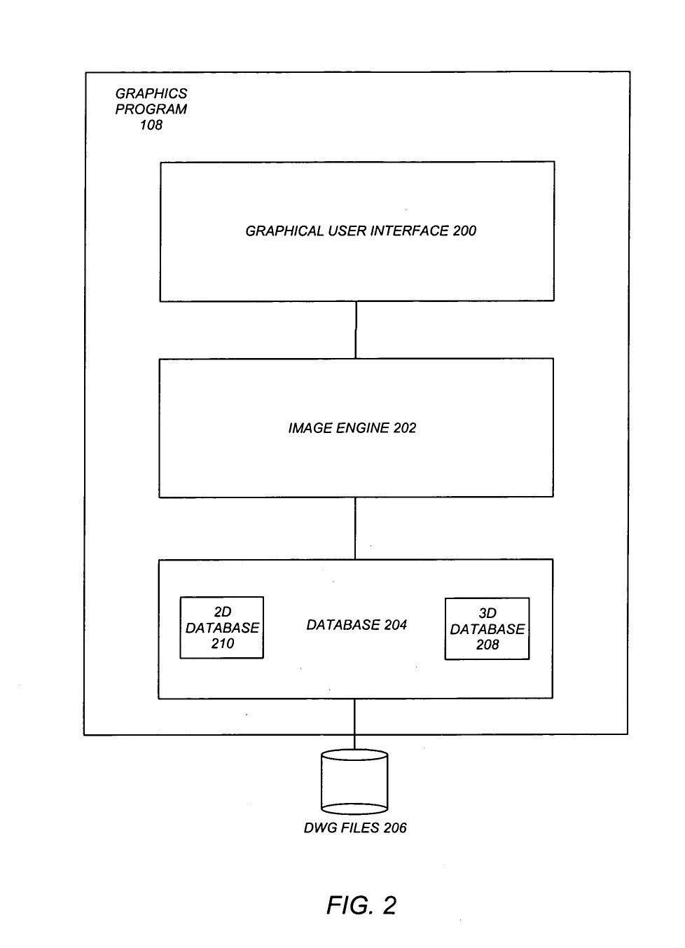

FIG. 2 is a block diagram that illustrates the components of the graphics program 108 in accordance with one or more embodiments of the invention. There are three main components to the graphics program 108, including: a Graphical User Interface (GUI) 200, an Image Engine (IME) 202, and a DataBase (DB) 204 for storing objects in Drawing (DWG) files 206.

The Graphical User Interface 200 displays information to the operator and provides the functionality for the operator's interaction with the graphics program 108.

The Image Engine 202 processes the DWG files 206 and delivers the resulting graphics to the monitor 102 for display. In one or more embodiments, the Image Engine 202 provides a complete application programming interface (API) that allows other computer programs to interface to the graphics program 108 as needed.

The Database 204 is comprised of two separate types of databases: (1) a 3D database 208 known as the “3D world space” that stores 3D information; and (2) one or more 2D databases 210 known as the “2D view ports” that stores 2D information derived from the 3D information.

### Object List

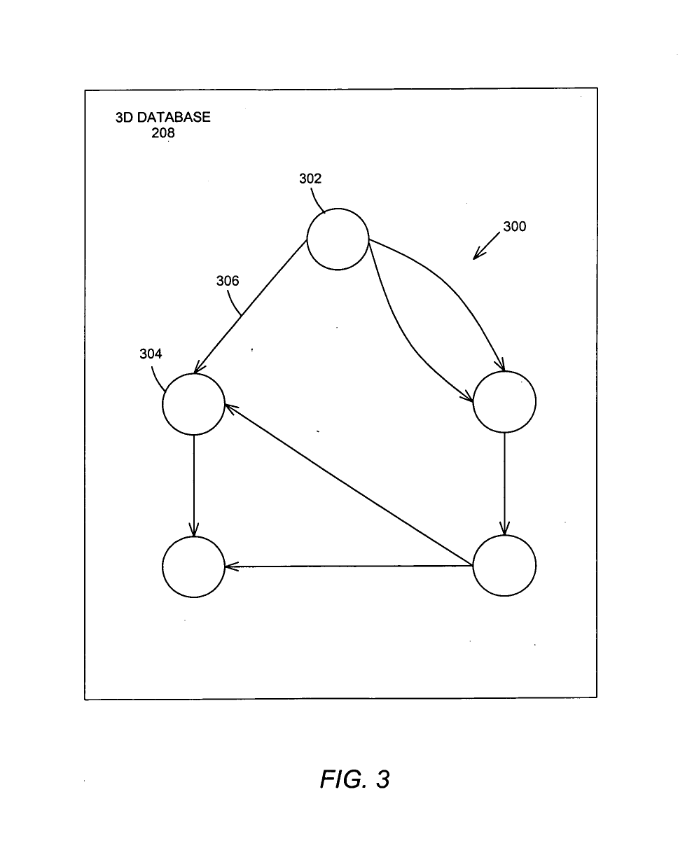

FIG. 3 is a block diagram that illustrates the structure of an object list 300 maintained by the 3D databases 208 in accordance with one or more embodiments of the invention. The object list 300 is usually comprised of a doubly linked list having a list head 302 and one or more objects 304 interconnected by edges 306, although other structures may be used as well. There may be any number of different object lists 300 maintained by the 3D databases 208. Moreover, an object 304 may be a member of multiple object lists 300 in the 3D databases 208.

### Software Embodiment Details

Graphics programs 108 that process 3D information are calculation intensive. Accordingly, users may not be able to interactively design/work in a mode where the display is fully rendered. As a consequence, such 3D programs 108 may employ an interactive working mode that uses a lower-quality rendering setting. The 3D program 108 may go to a higher quality mode either when explicitly triggered, during idle, manually or automatically (e.g., without user interaction).

The rendering quality adjustment is referred to as adaptive degradation since the rendering quality is degraded (or graded) adaptively based on the current rendering quality. Users may have the ability to determine whether adaptive degradation is on or off. Further users may have the ability to rank elements of the display over others (e.g., if the user wants to have shadows never degrade) (i.e., in the form of a degradation chain). Further, the user may adjust a target frame rate (referred to as FPS or frames per second). In an automatic mode, if the system is having trouble keeping up with the target/user specified FPS (e.g., the FPS is lower than the target frame rate), adaptive degradation will be used to degrade the rendering quality to dynamically achieve the FPS. Further, once the FPS increases, the adaptive degradation will increase the rendering quality to achieve the target FPS.

An additional aspect of the invention relates to visual styles. A visual style is an encapsulated set of display properties. In this regard, a user may elect to define multiple visual styles that may be used in particular situations. For example, one visual style may utilize full shadows while another visual style may merely be a bounding box (i.e., to quickly render images). A particular visual style is selected within which to work. Once a visual style has been identified, if the rendering quality is degraded (or upgraded), such a degradation (or modification) is temporary within the visual style. Thus, the visual style and the settings of the visual style will not change.

The display properties that may be adjusted to establish a particular visual style or to achieve the desired frame rate may be set forth in a variety of visual style settings (also referred to as display properties). For example, visual style settings that can be degraded may include:
View-Dependent Objects
Line Anti-aliasing
Lighting (On→Off)
Transparency Quality (High or Medium to Low)
Full Shadows (On→Off)
Transparency (On→Off)
Discard Back Faces (On→Off)
Ground Shadows (On→Off)
Edge Styles (On→Off)
Facet Edges to Isolines
Fast Silhouettes (On→Off)
Textures (On→Just Materials)
Materials (On→Off)
Lighting Quality (Smooth→Facets)
Intersection Edges (On→Off)
Faceted Display (On→Off)
Wireframe Display (On→Bounding Box)

Different visual style settings may also be degraded. For example, the following presents a set of different settings:
Face Style to Edges only
Hidden Edge Mode to Wire Mode
Lighting Quality→can be lowered (Smooth to Facets)
User Lighting→Pleasant Default Lighting
Shadows→Ground Shadows
Ground Shadows→OFF
Silhouette Lines can be turned OFF
Shadows→can be turned OFF
Materials and Textures→Textures can turn off, then materials can turn off
Backgrounds→can be turned OFF
Opacity→can be turned OFF

In addition to visual style settings, performance settings may also be adjusted or degraded. However, one or more embodiments may not provide the ability to degrade performance settings. Examples of Performance Settings that it may be possible to degrade include:
Anti-aliasing→can be turned OFF
Shadow Detail→can be lowered
Transparency Detail→can be lowered
Model detail→75% of user set values
Model detail→50% of user set values
Model detail→25% of user set values
Discarding of Back Faces→can be turned ON

In view of the above, display properties/settings may include the following: face style-edge style (bounding box→wireframe→share/hidden), lighting quality (flat→Gouraud→Phong), shadows (none→full shadows), lighting (default lighting→user defined, more advanced lighting), materials (materials off→textures on), edge and line effects (silhouettes→all edge effects), and transparency (none→low [screen door]→high [real]).

Each of the above properties/settings (visual style or performance) may be placed into/removed from a degradation chain/path that specifies the order/sequence for adjusting the rendering quality of a display. Further, the order/sequence of the properties/settings may be adjusted by the user. The order/sequence determines the order in which the particular property is adjusted when adjusting the rendering quality. In addition, a default degradation order/chain is/may be provided by the graphics program 108.

Each and every setting in a degradation chain may not be utilized when adjusting the rendering quality. In this regard, as the system processes a modification to the rendering quality and is traversing the degradation chain, if a particular property/setting is already off or on as the rendering quality is adjusted, the particular property has no effect. For example, if the “anti-aliasing off” property is encountered in the degradation and the anti-aliasing is already off, the particular property/setting will have no effect on the rendering quality and no action may be taken.

The following examples illustrate possible degradation chains in accordance with one or more embodiments of the invention:

(1) Anti-aliasing off, shadow quality from high to low, transparency quality from high to low, full shadows to ground shadows, transparency from on to off, discard back faces from off to on, model details to 75%, ground shadows to no shadows, facet edges to iso lines, silhouette lines off, model details to 50%, textures off, materials off, smooth light quality to facet light quality, model details to 25%, backgrounds off, face style from real or Gooch to None (may include setting edge mode from none to isolines), bounding box.

The following degradation chain adjusts the above path by removing some of the items. The degradation chain provides for a hidden visual style with full shadows on and assumes some transparent objects:

(2) Anti-aliasing off, shadow qualities from high to low, transparency quality from high to low, full shadows to ground shadows, transparency from on to off, discard back faces from off to on, model details to 75%, ground shadows to no shadows, facet edges to isolines, silhouette lines off, model details to 50%, backgrounds off, model details to 25%, and bounding box.

Regardless of the degradation chain, embodiments of the invention provide the ability for the user to adjust the master order for all chains. The chain is defined on a global basis and users may not be permitted to adjust a degradation chain on a per visual style basis (e.g., one visual style may not have shadows degraded first and another visual style have shadows degraded last). Alternatively, embodiments may permit a per visual style degradation chain. As described above, in an automated mode, the degradation chain may be invoked when the frame rate (i.e., FPS) of an active viewport drops below the target frame rate defined by the user.

Embodiments may also not permit a degradation chain to be saved over a visual style. In such an embodiment, the user cannot save a visual style in a degraded mode. For example, if the user explicitly/manually degrades the rendering quality and then saves the document/image, the visual style that was explicitly degraded will not have its definition overwritten with the degraded values.

Depending on the display driver utilized, the order in the degradation chain may need to be modified. For example, in directX™, the bottleneck to produce the display at a certain quality may be different than in openGL™ or a software Z-buffer™. Embodiments of the invention may take in as its input, a different degradation chain and default ordering of how items degrade. Such an input and/or use of a different degradation chain may be transparent to the user and without user knowledge/input or interaction.

One or more embodiments of the invention may also provide that the user cannot plot/print when in a degraded state unless the user has forcibly/manually altered the degradation level. Accordingly, because normal degradation may occur while in a particular command (e.g., orbit, stretch, walkthrough, etc.), the user may never have the problem of accidentally plotting such a degradation. Further, a warning dialog may be displayed when the degradation has been forcibly/manually adjusted and the user plots/publishes/prints.

### Degradation Caching

A caching or fluid degradation jumping scheme may also be utilized to provide the user with the best possible appearance. Possible settings may include per-command caching, general caching and degradation chain jumping.

With per-command caching, a degradation level may be cached on a per-command basis. For example, if a user enters a 3D orbit mode, the user may orbit and an appropriate degradation level may be found that meets the target frame rate. Later in the session, the 3D orbit mode may be invoked again. Instantly, the program may switch to the degradation level previously found (i.e., based on the cached degradation level associated with the 3D orbit mode). Thus, every time a target frame rate is found/calculated/determined for a particular command, the per-command degradation level is cached to provide the user with the most detailed display available given the user's requested task.

With per-command caching, a case may arise where the degradation stored is in fact much lower than the average case per command. To mitigate any such negative effects, after the program 108 has switched to a cached degradation level, a quick check may be executed that determines if any upgrade is possible that would not lower the frame rate below the target frame rate.

General caching provides for caching a degradation path/level once per session. Thereafter, if the frame rate drops below the target frame rate, the cached degradation path/level is utilized. For example, assume the 3D orbit mode is invoked, the appropriate degradation level is found and cached, and later in the session, the 3D orbit mode is invoked again. The general caching would provide that the cached degradation level is utilized. Similarly, if the user later enters a 3D walk mode, the same 3D orbit mode degradation level would be used since it is in cache. Thus, the same degradation level is always used when the frame rate drops below the target rate.

However, similar to the per-command caching, multiple commands may be degraded more than necessary. To mitigate any such negative effects, after the program 108 has switched to the cached degradation level, a quick check may be executed that determines if any upgrade is possible that would not lower the frame rate below the target frame rate.

With degradation chain jumping, the degradation chain traversing system may be more intelligent regarding how particular features are degraded/upgraded. For example, if dropping/increasing one level of the degradation chain only improved the frame rate by one (1) FPS, then the next drop may progress three (or some other arbitrary number) degradation levels on the chain. Such degradation jumping may ensure that a stable frame rate is established.

It should also be noted that the reverse caching (i.e., when increasing the frame rate back towards the selected visual style or when increasing the rendering quality), the various caching mechanisms above may be utilized.

### Degradation Chain Dialog Box

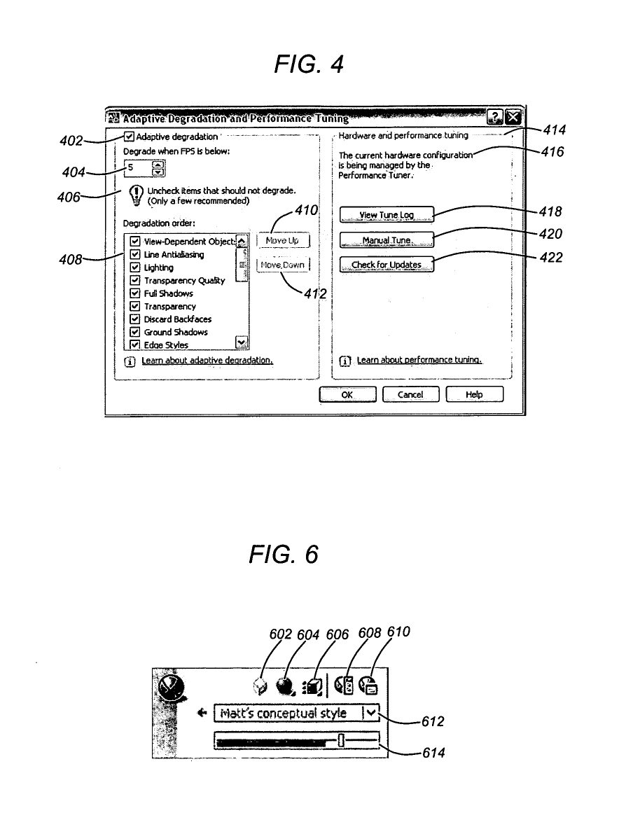

FIG. 4 illustrates a dialog window used to modify a degradation chain in accordance with one or more embodiments of the invention. The adaptive degradation checkbox 402 indicates whether automatic adaptive degradation is active or not. If unchecked/inactive, manual tuning may still be performed but the degradation will not be performed automatically by the system.

The numeric spinner box 404 indicates the user set target frame rate (or frame per second). Changing the value in the box 404 alters the frame rate/FPS value that triggers adaptive degradation to commence when in an interactive viewport. Thus, the application will commence automatically degrading the rendering quality when the frame rate/FPS is below the specified value.

Instructional label and information icon 406 provides instructions to the user for adjusting the degradation chain. As illustrated, the instructions indicate that the user can add/remove a particular display property by unchecking/checking the box adjacent to the time.

Degradation chain order box 408 provides the listing of the display properties that are active and the order in which they will be degraded. The checked boxes determine the items the user can choose to degrade or not to degrade. When an item is checked, the item will be left in the degradation chain during degradation. When an item is unchecked, the item will not be degraded unless the item must be degraded.

The listing 408 also allows the user to order how the degrading is to occur. To determine the order, the user may utilize move up button 410 and move down button 412. The user selects an item from within the box 408 and either clicks on move up 410 or move down 412. When the move up button 410 is clicked (e.g., using a cursor control device 106), the item currently selected alternates places with the item above it. Both items likely retain their current checkstate. When the move down button 412 is clicked, the item currently selected in the checked list box 408 alternates places with the item below it. It may also be noted that some of the settings within checked box list 408 may be dependent on various hardware resource issues. Accordingly, some settings/elements within checked box list 408 may not display, may be dimmed, or may not be selectable.

The Hardware and Performance Tuning box 414 houses the controls related to the performance tuner and hardware settings. Status label 416 indicates whether the application (e.g., AutoCAD™) is managing the hardware configuration or whether the user has manually adjusting the settings. The View tune log button 418 allows the user to view a log of all tuning operations that have been performed. The Manual tune button 420 allows the user to open up a dialog to perform a manual tuning operation. Such a manual tuning operation may comprise the ability to manually adjust various settings for the rendering quality.

### Manual Performance Dialog Box

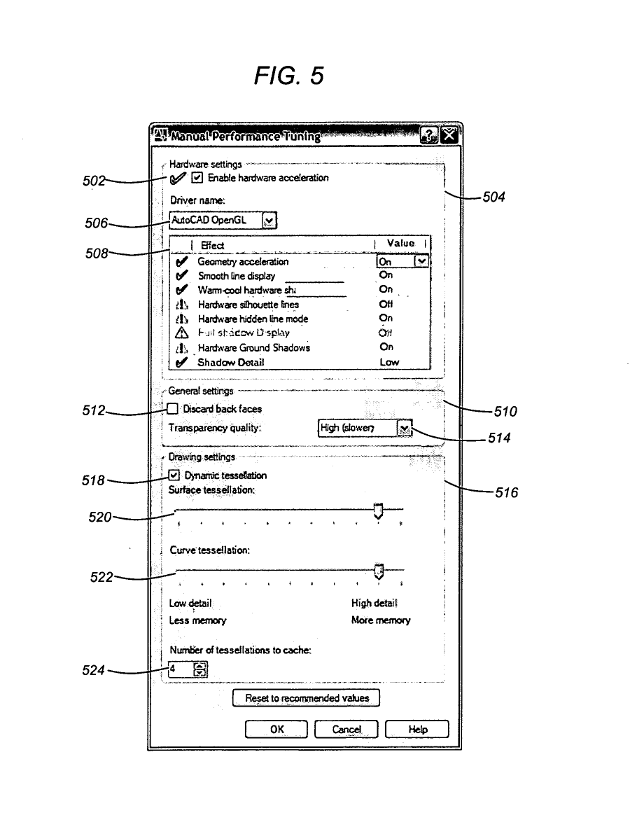

FIG. 5 illustrates a dialog box displayed when the user clicks the manual tune button 420 of FIG. 4. The manual tune dialog box allows the user to manually establish various settings for the rendering quality. The enable hardware acceleration checkbox 502 (within the hardware settings group box 504) determines whether hardware acceleration is active and whether the graphics system will adjust itself accordingly. Such hardware acceleration would rely on a graphics processing unit (GPU) within computer 100. Certain GPU cards may or may not be selectable or certified for hardware acceleration during manual performance tuning. The driver name box 506 determines the driver that will be used for the GPU during hardware acceleration.

The hardware effects list 508 is the location for configuring the user's hardware. The user will be presented with three pieces of information organized into three columns. The first column is the hardware certification status presented as an icon. The second column is the effect name. The third column is the effect value. The hardware certification status icon determines if the particular listed effect is allowed/supported, disabled/non-supported, or caution/works but is not recommended. The value list may provide a combo-box that is dynamically placed over the cell that is clicked. The combo-box requires the necessary values relating to the particular effect. The first click may only select the text of the item and display the combo-box drop arrow. Thereafter, the user can click on the drop-down arrow and select an item. The values available for the various effects may be limited based on the settings described above.

The general settings group box 510 contains performance related options that are not hardware dependent. For example, the discard back faces check box 512 determines whether the graphics system draws the back facing faces/polygons. If unchecked, all faces, both front ant back, are drawn. The transparency quality label combo box 514 determines the transparency quality such as low, medium, or high.

The drawing settings group box 516 contains performance values that affect drawings on a per drawing basis. The tessellation options 518-524 provide controls relating to tessellating a drawing.

### Visual Style Panel

As described above, the user may establish a visual style comprised of an encapsulated set of display properties/elements. A visual style is used/assigned to a viewport. However, the rendering quality for a particular viewport may degrade or fall below the established frame rate/FPS. When the current frame rate drops below the designated target frame rate, the system may begin the automatic adaptive degradation process. During such a process, the rendering quality is reduced based on the degradation chain until the designated target frame rate is achieved. Achieving such a frame rate may consist of various adjustments degrading and then improving the rendering quality to achieve the particular rate desired.

During the degradation process (and subsequent to the degradation process), the visual style remains the same for the particular viewport. Thus, the degradation or change to the rendering quality is only temporary for the particular visual style.

While the automated process may be utilized to achieve the desired rate, the user may also manually adjust the rendering quality based on the degradation chain. FIG. 6 illustrates a dialog or visual style panel that may be used to manually adjust the rendering quality in accordance with one or more embodiments of the invention. The panel may provide a series of controls that enables the user to quickly toggle aspects of the display without having to create an entirely new visual style. Further, the panel provides a visual degradation slider as well as a drop-down list for actually changing/swapping the visual style.

The x-ray toggle tool button 602 toggles an x-ray effect on/off for a particular viewport. The x-ray effect reflects a particular level of opacity for the viewport. The shadow mode flyout tool button 604 allows the user to quickly toggle through the shadow settings for the viewport from shadows off to ground shadows to full shadows. The face color mode drop-down 606 allows the user to quickly toggle through the face colors from regular color mode to monochrome mode to tint mode to desaturate mode.

The degradation and tuning button 608 launches the degradation and tuning dialog of FIG. 4. The visual styles ESW button 610 launches a visual styles manager that allows the user to manipulate, modify, change, etc. a particular visual style.

The visual styles combo box 612 provides a mechanism for the user to switch to a different visual style (e.g., for a particular selected viewport). When a particular visual style is selected using the combo-box, the selected visual style is applied to the current/selected viewport. The control 612 may be disabled when there are no currently active viewports or only particular types of viewports (e.g., paper space viewports).

The degradation slider 614 is a visual style progress slider. The slider is the user's view into the level that the current visual style of the current viewport has degraded to. The range of the slider 614 is the total number of hops (links) on the degradation chain minus any items that are inactive/unchecked in the degradation chain control (i.e., box 408) that the visual style in the current viewport has. The starting value may always be equal to the upper bound of the range. Tick marks may also be used to represent the range of the slider 614.

When the thumb of the slider 614 is changed, the degradation level of the visual style in the current viewport is forcibly/manually altered. The user can move the slider to quickly alter the display/performance quality of the system. As the slider moves from tick to tick, a tooltip may be displayed to show the user what is being degraded with each tick change. For example, if the user drags one tick over, a tooltip may display noting that “Shadows have turned off”. As the user drags the slider from left to right, the opposite may occur. For example, a tooltip may display outlining what will be/is being enabled. As the user drags over multiple ticks, the tooltip may grow with one new line for each tick crossed. For example, if the user has dragged three ticks to the left, the tooltip may be a three (3) line tooltip that would display:
“Shadows off”
“Transparency off”
“Smooth lines off”

### Logical Flow

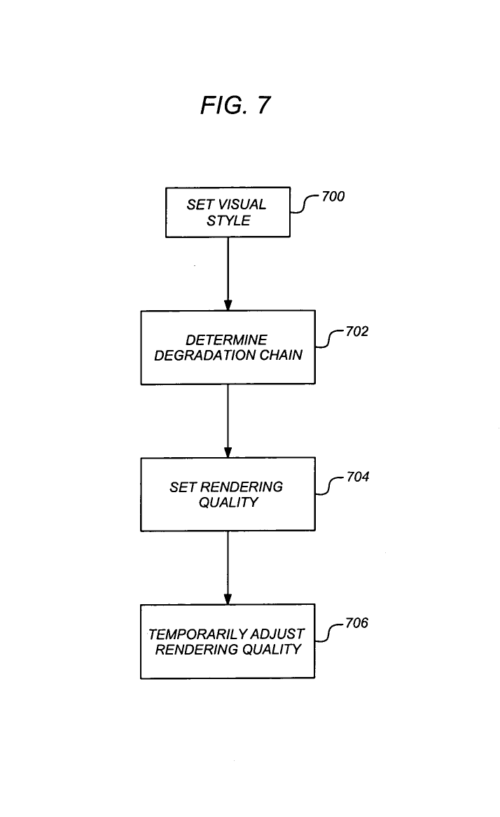

FIG. 7 is a flow chart illustrating the logical flow for rendering a display in accordance with one or more embodiments of the invention. At step 700, the visual style is set. As described above, the visual style comprises an encapsulated set of one or more display properties. Alternatively, embodiments of the invention may not utilize a visual style or an encapsulated set of properties. In such an embodiment, step 700 may not be performed.

At step 702, an adaptive degradation chain is determined/established/created. The chain comprises an ordered sequence of the display properties, wherein the ordered sequence determines an order for changing the display properties when adjusting a rendering quality of the display/viewport. The degradation chain may be user configurable such that the user can modify/change the ordered sequence and/or add/remove one or more display properties from the chain (e.g., by unchecking a property).

At step 704, the rendering quality is set. If visual styles are being utilized, the rendering quality may be set at step 704 in accordance with one or more of the properties set in the visual style. Alternatively, the rendering quality may be required to utilize all of the properties set in the visual style.

At step 706, the rendering quality is temporarily adjusted (while remaining within the visual style if visual styles are being utilized) by changing one or more of the display properties based on the adaptive degradation chain. Such temporary adjusting may be performed by a user manually adjusting the rendering quality (e.g., using a degradation slider comprised of a progress slider indicating a level [e.g., of the visual style] that the rendering quality is currently set to).

Alternatively, the temporary adjusting is automatically performed without user interaction. With automatic degradation, a target performance setting (e.g., a frame rate) is determined/established. The system then determines if a current performance complies with the target performance setting. If the current performance fails to comply with the target performance setting, the rendering quality is automatically adjusted (e.g., within the visual style) by automatically changing one or more of the display properties based on the adaptive degradation chain. The failure to comply may arise when the current performance is below the target performance setting such that the rendering quality is automatically temporarily adjusted to provide a lower rendering quality.

Once lowered, the system may monitor the current performance (i.e., with the changed/lowered properties) and determine if the current performance is above the target performance setting. The rendering quality may then be increased (based upon/using the adaptive degradation chain) to achieve the target performance setting.

An example of the use of automatic adaptive degradation with visual styles follows. Suppose the current visual style is set to “A” and the system determines that the frame rate is dropping. The system may access the degradation chain and determine that the transparency needs to be turned off. Thereafter, the system may wait to determine if the frame rate increases. If the frame rate increases (e.g., beyond the target rate), the transparency may get turned back on. It is noted that while the rendering quality is degraded and changed, the user/viewport remains in visual style “A”. Further, the user does not need to return to turn back on the visual style. Instead, once the display can recover and achieve the target frame rate under the maximum settings for the visual style, the system will automatically and appropriately adjust the settings.

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention. In summary, embodiments of the invention provide the ability to establish the manner in which a system will degrade the rendering quality.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-implemented method for rendering a display, comprising:
determining an adaptive degradation chain comprised of an ordered sequence of the display properties, wherein the ordered sequence determines an order for changing the one or more display properties when adjusting a rendering quality;
setting the rendering quality in accordance; and
temporarily adjusting the rendering quality by changing one or more of the display properties based on the adaptive degradation chain.

2. The method of claim 1, further comprising setting a visual style comprising an encapsulated set of one or more display properties, wherein:
the rendering quality is set in accordance with the visual style; and
the rendering quality is temporarily adjusted within the visual style.

3. The method of claim 1, wherein the temporary adjusting is performed by a user manually adjusting the rendering quality.

4. The method of claim 3, wherein the user manually adjusts the rendering quality using a degradation slider comprised of a progress slider that indicates a level that the rendering quality is currently set to.

5. The method of claim 1, wherein the temporarily adjusting comprises:
determining a target performance setting;
determining if a current performance complies with the target performance setting; and
if the current performance fails to comply with the target performance setting, automatically adjusting the rendering quality by automatically changing one or more of the display properties based on the adaptive degradation chain.

6. The method of claim 5, wherein the target performance setting comprises a frame rate.

7. The method of claim 5, wherein the current performance fails to comply with the target performance setting when the current performance is below the target performance setting, and wherein the rendering quality is automatically temporarily adjusted to provide a lower rendering quality.

8. The method of claim 7, further comprising:
determining if the current performance with the changed one or more display properties is above the target performance setting; and
automatically adjusting the rendering quality by increasing the rendering quality using the adaptive degradation chain.

9. The method of claim 1, wherein the adaptive degradation chain is user configurable such that the ordered sequence, of the one or more display properties in the adaptive degradation chain, can be changed by the user.

10. The method of claim 1, wherein the adaptive degradation chain is user configurable such that the one or more display properties in the degradation chain can be added or removed by the user.

11. An apparatus for rendering a display in computer system comprising:
(a) a computer having a memory;
(b) an application executing on the computer, wherein the application is configured to:
(i) determine an adaptive degradation chain comprised of an ordered sequence of the display properties, wherein the ordered sequence determines an order for changing the one or more display properties when adjusting a rendering quality;
(ii) set the rendering quality in accordance; and
(iii) temporarily adjust the rendering quality by changing one or more of the display properties based on the adaptive degradation chain.

12. The apparatus of claim 11, wherein the application is further configured to set a visual style comprising an encapsulated set of one or more display properties, wherein:
the rendering quality is set in accordance with the visual style; and
the rendering quality is temporarily adjusted within the visual style.

13. The apparatus of claim 11, wherein the application is configured to temporarily adjust the rendering quality via a user manually adjusting the rendering quality.

14. The apparatus of claim 13, wherein the user manually adjusts the rendering quality using a degradation slider comprised of a progress slider that indicates a level that the rendering quality is currently set to.

15. The apparatus of claim 11, wherein the application is configured to temporarily adjust the rendering quality by:
determining a target performance setting;
determining if a current performance complies with the target performance setting; and
if the current performance fails to comply with the target performance setting, automatically adjusting the rendering quality by automatically changing one or more of the display properties based on the adaptive degradation chain.

16. The apparatus of claim 15, wherein the target performance setting comprises a frame rate.

17. The apparatus of claim 15, wherein the current performance fails to comply with the target performance setting when the current performance is below the target performance setting, and wherein the rendering quality is automatically temporarily adjusted to provide a lower rendering quality.

18. The apparatus of claim 17, wherein the application is further configured to:
determine if the current performance with the changed one or more display properties is above the target performance setting; and
automatically adjust the rendering quality by increasing the rendering quality using the adaptive degradation chain.

19. The apparatus of claim 11, wherein the adaptive degradation chain is user configurable such that the ordered sequence, of the one or more display properties in the adaptive degradation chain, can be changed by the user.

20. The apparatus of claim 11, wherein the adaptive degradation chain is user-configurable such that the one or more display properties in the degradation chain can be added or removed by the user.

21. An article of manufacture comprising a program storage medium readable by a computer and embodying one or more instructions executable by the computer to perform a method for rendering a display of a computer system, the method comprising:
determining an adaptive degradation chain comprised of an ordered sequence of the display properties, wherein the ordered sequence determines an order for changing the one or more display properties when adjusting a rendering quality;
setting the rendering quality; and
temporarily adjusting the rendering quality by changing one or more of the display properties based on the adaptive degradation chain.

22. The article of manufacture of claim 21, wherein the method further comprises setting a visual style comprising an encapsulated set of one or more display properties, wherein:
the rendering quality is set in accordance with the visual style; and
the rendering quality is temporarily adjusted within the visual style.

23. The article of manufacture of claim 21, wherein the temporarily adjusting comprises:
determining a target performance setting;
determining if a current performance complies with the target performance setting; and
if the current performance fails to comply with the target performance setting, automatically adjusting the rendering quality by automatically changing one or more of the display properties based on the adaptive degradation chain.

24. The article of manufacture of claim 21, wherein the adaptive degradation chain is user configurable such that the ordered sequence, of the one or more display properties in the adaptive degradation chain, can be changed by the user.
